(19) United States
(12) Patent Application Publication
(10) Pub. No.: US 2026/0314613 A1
(43) Pub. Date: Oct. 15, 2026

(54) TROUGH AND TROUGH CONVEYOR, CONFIGURED AND ADAPTED TO TRANSPORT FISH TRANSVERSELY TO THEIR LONGITUDINAL EXTENT

(71) Applicant: Nordischer Maschinenbau Rud. Baader GmbH + Co. KG, Lübeck (DE)

(72) Inventor: Branden Jared Goldmann, Lübeck (DE)

(73) Assignee: Nordischer Maschinenbau Rud. Baader GmbH + Co. KG, Lübeck (DE)

(21) Appl. No.: 19/484,568

(22) PCT Filed: May 17, 2023
(86) PCT No.: PCT/EP2023/063294

§ 371 Date: Nov. 14, 2025

(51) Int. Cl. A22C 25/08; A22C 25/12; B65G 17/12

(52) U.S. Cl. CPC A22C 25/08; A22C 25/12; B65G 17/12; B65G 2201/0202

(57) ABSTRACT

A trough, configured to receive fish which are able to be transported transversely to their longitudinal extent in a substantially horizontal transport plane E in a transport direction T by a trough conveyor. The trough includes at least one head support and at least one main support. Each main support includes a main body having a support surface parallel to the transport plane and a contact surface oriented substantially perpendicular to the support surface. The contact surface is formed by a divider oriented at an angle β≠0 relative to a longitudinal axis L of the trough. The divider divides the support surface of the main support into two separate regions, namely in particular into a body support region and a tail support region.

### CROSS-REFERENCE TO RELATED APPLICATION

The present application is the National Phase entry of International Patent Application No. PCT/EP2023/063294 filed May 17, 2023, the contents of which are herein incorporated by reference.

### TECHNICAL FIELD

The present disclosure relates to a trough, configured and adapted to receive fish which are able to be transported transversely to their longitudinal extent in a substantially horizontal transport plane E in a transport direction T by a trough conveyor, wherein the trough comprises at least one head support and at least one main support, wherein each main support comprises a main body having a support surface parallel to the transport plane E and a contact surface oriented substantially perpendicular to the support surface.

The present disclosure relates further to a trough conveyor, configured and adapted to transport fish transversely to their longitudinal extent in a transport direction T, comprising a transport conveyor which can be driven in a revolving manner, having a transport run defining the transport plane E and a return run, wherein the endless transport conveyor is guided around at least two deflection elements, which are rotatable about an axis of rotation D, for driving and/or guiding the transport conveyor, and troughs for receiving fish are arranged on the transport conveyor, wherein the troughs are oriented with their longitudinal axis L transverse to the transport direction T.

### BACKGROUND

Such troughs and trough conveyors are used in the fish-processing industry in order to transport the fish, which are lying in the troughs on their side—for example stomach first—in an accurate position into the region of a processing station, for example a station for beheading the fish, and/or to a transfer region, where, namely in the transfer region from the transport run to the return run, they are delivered in a purposive and oriented manner when the troughs follow the transport conveyor as it is deflected around the deflection element. The trough conveyor can serve as a stand-alone apparatus solely for transport purposes or is part of a fish-processing machine for transporting along processing stations in such a manner that the fish, lying in the troughs, are subjected to processing, for example beheading. In particular in the case where the trough conveyor is part of a fish-processing machine, a further transport means is arranged downstream of the trough conveyor to form an arrangement, such that the fish are to be transferred from the trough conveyor to the downstream transport means.

When the fish are being beheaded, it is crucial that the separating means for beheading the fish cut as close as possible along the collarbone of the fish in order to harvest as much of the neck meat as possible. In other words, neck meat must be prevented from also being separated from the fish body when the beheading cut is made. By the trough conveyor, the fish are transported stomach first, with their back lying against a contact surface of the trough, into the region of the station for beheading the fish and are also positioned relative to the separating means during the actual separating process. The trough conveyor with its troughs thus has a positioning function in addition to the transport function.

In the trough conveyors known hitherto, in which the troughs are oriented with their longitudinal axis transverse to the transport direction, transverse in the sense of substantially perpendicular, losses of yield occur in the region of the collarbone when the beheading cut is made, such that meat that is present in the region of the collarbone is separated from the later filet together with the head. Since in the case of the known troughs the contact surfaces of the troughs are arranged at the rear edge, which is trailing in the transport direction, the fish lie with their longitudinal axis perpendicular to the separating cut plane S, so that the mentioned losses of yield occur. In order to reduce this effect, DE 200 08 828 U1 proposes positioning the troughs as a whole obliquely on the transport chain, so that the fish lie with their longitudinal axis oblique, such that the separating cut runs in a plane that does not run perpendicular to the longitudinal axis of the fish. Owing to the oblique mounting of the troughs on the transport conveyor, it is necessary for the transport conveyor to have a structure that is different compared to the conventionally mounted troughs, the longitudinal axis of which is oriented substantially perpendicularly to the transport direction in the transport plane, which in particular makes it difficult to retrofit existing trough conveyors with troughs.

Accordingly, the object underlying the present disclosure is to propose a universally usable and readily retrofittable trough which allows the neck meat to be obtained in a yield-efficient manner when the fish are beheaded. The object further includes providing a corresponding trough conveyor.

### SUMMARY

This object is achieved by a trough mentioned at the beginning in that the contact surface is formed by a divider oriented at an angle β≠0 relative to the longitudinal axis L of the trough, wherein the divider divides the support surface of the main support into two separate regions, namely in particular into a body support region and a tail support region. With the oblique orientation of the divider, the trough on the one hand forms a contact surface for the fish, which allows the fish to be transported obliquely such that the separating cut runs in a plane that does not run perpendicular to the longitudinal axis of the fish. On the other hand, the trough with the main support can itself be mounted with its longitudinal axis perpendicular to the transport direction T, so that this trough can be adapted to existing systems. In other words, this trough combines the aspects of a trough that is oriented with its longitudinal axis perpendicular to the transport direction T, which facilitates mounting and in particular retrofitting, with the possibility of transporting the fish obliquely in order to obtain the neck meat in a yield-efficient manner when the fish are beheaded.

In embodiments, the divider of the trough extends approximately from a point of intersection between an end face, facing away from the head support, of the main support with a front edge, pointing in the transport direction T, of the main support, in the opposite direction to the transport direction T, approximately to a point of intersection between an end face, facing the head support, of the main support with a rear edge, pointing in the opposite direction to the transport direction T, of the main support. To put it simply, the divider extends diagonally across the support surface, whereby the oblique position of the fish to be positioned is prescribed. The divider can of course have a different run, as long as a contact surface that runs obliquely relative to the longitudinal axis L, oriented perpendicular to the transport direction T, of the troughs is formed. With the run according to the present disclosure, optimal positioning of the fish for maximum yield efficiency is achieved.

In embodiments, each head support comprises a main body having a support surface parallel to the transport plane E and a contact surface oriented substantially perpendicular to the support surface, wherein the contact surface of the head support is configured at a rear edge, trailing in the transport direction T, of the head support and extends as a continuation of the contact surface of the main support. This configuration, in a simple and space-saving manner, allows the fish to be positioned obliquely in the trough over the entire fish length, in order on the one hand to orient the fish obliquely relative to the separating plane S during transport and on the other hand also to hold them securely in position during processing.

In embodiments, the divider has in the region of the side facing the head support an opening which extends perpendicular to the transport plane E in the direction towards the support surface of the main support. This opening, which may also be a recess or material depression, serves to avoid collisions with other machine parts, such as, for example, so-called fin catchers, measuring devices, pressure elements or parts thereof. The opening thus ensures that the troughs carrying the fish are transported continuously and without collision through processing stations, such as, for example, the station for beheading the fish. The size and the position of the opening can vary and in particular can extend over only part of the height of the divider. Optionally, the opening may also extend as far as the support surface of the main support.

In embodiments, the contact surface of the head support also has an opening which extends perpendicular to the transport plane E in the direction towards the support surface of the head support. This opening, which may also be a recess or material depression, serves to avoid collisions with other machine parts. The opening thus ensures that the troughs carrying the fish are transported continuously and without collision. The size and the position of the opening can vary and in particular can extend over only part of the height of the contact surface. Optionally, the opening may also extend as far as the support surface of the head support.

In embodiments, all regions of the support surface of the main support and the support surface of the head support of a trough lie in the same plane parallel to the transport plane E. Secure transport and stable positioning of the fish are thereby ensured, in particular also against the background that the head and body of a first fish and the tail of a second fish can be positioned on the same trough. Optionally, different planes may also be provided. For example, the tail support region can be higher than the body support and head support region, since the tail region of the fish is configured in principle flatter than the body of the fish.

In embodiments, the divider separates the support surface of the main support diagonally and is configured and adapted on the side pointing in the transport direction T as a linear stop for the back of the fish to be transported. This form supports the oblique transport and positioning of the fish with the trough oriented substantially vertically relative to the transport direction T.

In embodiments, the angle β enclosed between the longitudinal axis L of the trough and a longitudinal axis L_{T} of the divider has a size between 5 and 45 degrees, between 10 and 30 degrees, or between 15 and 20 degrees. With this oblique position, an optimal angle at which a separating means of a station for separating the head from the body meets the fish to be beheaded is achieved. In embodiments, the angle range permits a particularly yield-efficient beheading cut.

In embodiments, the divider is configured integrally with the main body. Correspondingly, the contact surface of the head support is also configured integrally with the main body of the head support. This permits simple manufacture, for example by injection moulding or dead-mould casting, and forms a stable and loadable trough and a secure hold of the fish in the trough. The divider, or the contact surface, can also be configured separately to the main body and, for example, be fitted or connected in another manner, in embodiments, releasably, to the main body.

In embodiments, the divider divides the support surface into two substantially triangular partial surfaces, wherein the partial surface pointing in the transport direction T for forming the body support region is configured to be larger than the partial surface facing away from the transport direction T for forming the tail support region. This division ensures that a sufficient and maximum support surface is provided for the fish with its centre of mass. The body requires maximum support for precise positioning, while the tail merely has to be secured against “bending downwards”. The divider can also divide the support surface of the main support into other geometric surfaces with a different size distribution. However, the claimed division provides a space-optimised and functionally optimised solution.

In embodiments, the thickness of the divider perpendicular to the support surface decreases, starting from the side facing the head support, in the direction towards the side opposite the head support. An embodiment that is space-saving and above all adapted to the anatomy of the fish is thus provided. The thickness of the fish—lying on its side—decreases from the head in the direction towards the tail, so that the divider is only as high, or thick, as is necessary on the part of the fish. The height, or thickness, of the divider can of course vary. The same is also true for the width of the divider. The wider the divider, the smaller the contact surface. Accordingly, the trough may also optionally be adapted to different fish sizes over the width of the divider by the provision of, for example, supplementary insert elements or the like, which can be fitted to the separating walls.

In embodiments, the head support and the main support are configured as separate components and are arranged spaced apart from one another to form a gap. This configuration ensures, in a simple manner, that there is sufficient space between the main support and the head support for the separating means to cut through the fish without collision.

In embodiments, a longitudinal axis L_{K} of the head support is oriented at an angle to a longitudinal axis L_{H} of the main support. In embodiments, the longitudinal axis L_{K} of the head support, starting from the longitudinal axis L of the trough, which runs perpendicular to the transport direction T, runs obliquely backwards in the opposite direction to the transport direction T in the transport plane E or parallel thereto. In other words, the main body of the head support is disposed obliquely on the main body of the main support, such that a common oblique support surface is provided for the fish. In this manner, it is ensured that the fish are positioned particularly precisely in the oblique position, the longitudinal axis of the fish accordingly does not run perpendicular to the transport direction T, in the trough, the longitudinal axis L of which is oriented perpendicular to the transport direction. By “bending” the head support, optimal positioning of the fish is ensured in a particularly compact and space-saving manner, permitting a yield-efficient separating cut.

In embodiments, the front edges, pointing in the transport direction T, of the main support and the head support are in each case oriented parallel to the rear edges, pointing in the opposite direction to the transport direction T, of the main support and the head support, wherein the edges of the main support are oriented transverse to the transport direction T and parallel to the longitudinal axis L of the trough, and the edges of the head support are inclined obliquely backwards, starting from the main support, in the opposite direction to the transport direction T. With this configuration, the above-described aspects are further supported.

In embodiments, each trough comprises, in addition to the main support and the head support, a fastening element which is arranged at the end of the main support opposite the head support. By the additional fastening element, in embodiments, likewise comprises a plate-like main body, the trough according to the present disclosure can be exchanged quickly and easily for other troughs with the same fastening structure. The head support and the fastening element together serve to fasten the trough securely and in such a manner that it is guided on both sides.

In embodiments, the three components of a trough, that is to say the fastening element, the main support and the head support, are connected together via a bearing rod. Handling of the troughs during mounting and/or retrofitting is thus simplified. Furthermore, the precise association of the individual components with one another also remains in the non-mounted state, so that the outlay on retrofitting or refitting is reduced.

In embodiments, at least the fastening element and the head support comprise fastening means by which the trough is configured and adapted to be able to be mounted on the transport conveyor with its longitudinal axis L perpendicular to the transport direction T. In embodiments, the head support and the fastening element can have, for example, threaded bores on their underside facing away from the support surface, which threaded bores all lie on a linearly oriented axis which runs parallel to the longitudinal axis L of the trough. The axis A can lie on the longitudinal axis L or spaced apart therefrom. With this configuration, the trough according to the present disclosure can be integrated without reconstruction or adaptation measures into known systems, in particular into trough conveyors with an orientation of the troughs with a longitudinal axis L perpendicular to the transport direction T.

The object is also achieved by a trough conveyor mentioned at the beginning in that each trough is configured and adapted according to present disclosure. The aspects arising therefrom have already been described in connection with the trough and reference is therefore made, in order to avoid repetition, to the corresponding passages. With the troughs according to the present disclosure invention there is provided a trough conveyor according to the present disclosure by which secure transport and optimised positioning of the fish for processing, in particular for separation of the head from the body, are ensured.

In embodiments, two adjacent troughs form a complete support for a single fish, such that a fish can be positioned with its head on the head support of a first trough and with its body on the body support region of the main support of the first trough, while the tail of the same fish can be positioned on the tail support region of an adjacent second trough that is leading in the transport direction T. With this configuration and arrangement of the adjacent troughs, a desired oblique positioning of the fish can be achieved in a space-optimised manner without the troughs themselves being arranged obliquely.

In embodiments, the longitudinal axis L of each trough is oriented in the transport plane E perpendicular to the transport direction T. An exact perpendicular orientation—of course taking account of manufacturing and/or mounting tolerances—is thus described, which substantially facilitates the rapid and simple exchange and retrofitting of troughs in a space-saving manner.

In embodiments, the troughs are configured so as to be open on the side that is leading in the transport direction T, such that the fish lying in the troughs fall out of the troughs in the transfer region Ü from the transport run into the return run. With this design, the further guiding and/or further processing of the beheaded fish in the trough is ensured in a simple manner.

In embodiments, the transport conveyor comprises a transport chain, which is formed of multiple chain members. The transport chain forms a very robust and reliable transport conveyor, which also permits secure and fixed but releasable connection to the troughs.

In embodiments, each trough comprises, in addition to the main support and the head support, a fastening element which is arranged at the end of the main support opposite the head support, wherein each trough is releasably fastened in the region of the head support and of the fastening element to chain members of the transport chain. The above-described aspects are thus further supported.

In embodiments, threaded bores are configured on the underside, facing the transport chain, of the head support and of the fastening element, wherein all the threaded bores of a trough lie on a linear axis which is oriented transverse to the transport direction T and parallel to the longitudinal axis L of the trough. Instead of the threaded bores, other fastening elements may also be configured, such as, for example, plug-in and/or latching elements or the like.

In embodiments, the three components of a trough, that is to say the fastening element, the main support and the head support, are connected together via a bearing rod, such that the main support is movable, in particular rotatable, relative to the components head support and fastening element that are fixedly connected to the transport chain. Owing to the releasable connection of the head support and the fastening element to the transport chain, these components follow the movement path of the chain. The main support is movable relative thereto at least partially independently thereof, in order, for example, to allow the exact discharge position to be determined.

### BRIEF DESCRIPTION OF THE DRAWINGS

Further expedient and/or features and further developments of the trough conveyor will become apparent from the description. Embodiments, of the present disclosure will be explained in greater detail with reference to the accompanying drawing. The drawing shows:

FIG. 1 a schematic representation of the trough according to the present disclosure in a perspective view,

FIG. 2 the trough according to FIG. 1 in a top view,

FIG. 3 the trough according to FIG. 1 in a bottom view,

FIG. 4 two troughs according to FIG. 2 with a fish positioned thereon, and

FIG. 5 a schematic representation of a trough conveyor having multiple troughs according to FIG. 1.

### DETAILED DESCRIPTION

The trough shown in the drawing with the trough conveyor is configured and adapted to transport white fish, in particular of the species “cod and hake”, transaxially, stomach first, with their back at the trailing end of the trough. The troughs with the trough conveyor are very particularly configured and adapted to transport the fish into the region of and to position them in the region of a beheading machine. However, the troughs and also the trough conveyor are correspondingly also suitable for transporting and positioning fish of other species, in particular also in different size ranges of the fish.

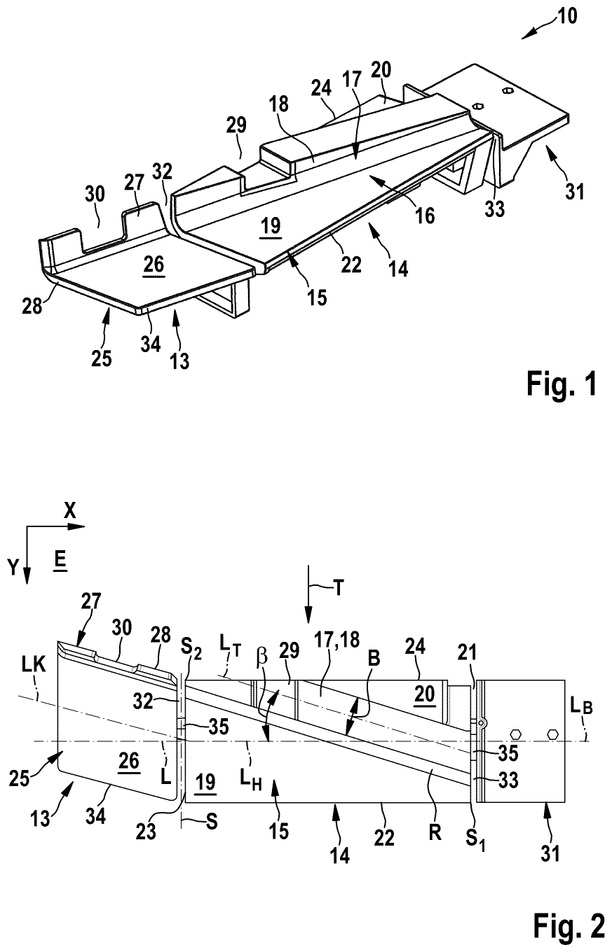

FIGS. 1 to 4 show a trough 10 which is configured and adapted to receive fish 11 which are able to be transported transversely to their longitudinal extent in a substantially horizontal transport plane E in a transport direction T by a trough conveyor 38. The trough 10 comprises at least one head support 13 and at least one main support 14, wherein each main support 14 comprises a main body 15 having a support surface 16 parallel to the transport plane E and a contact surface 17 oriented substantially perpendicular to the support surface 16.

This trough 10 is distinguished according to the present disclosure in that the contact surface 17 is formed by a divider 18 oriented at an angle β≠0 relative to the longitudinal axis L of the trough 10, wherein the divider 18 divides the support surface 16 of the main support 14 into two separate regions, namely in particular into a body support region 19 and a tail support region 20.

The features and further developments described below are embodiments when considered on their own or in combination with one another. It should explicitly be noted that features that are combined in the description and/or in the figures or that are described in a common embodiment can also further develop the above-described trough 10 functionally independently.

The divider 18 extends perpendicular to the support surface 16 of the main body 15. In the embodiment shown, the transition from the divider 18 to the main body 15 is provided with a radius R, wherein the size of the radius can vary and may optionally also be replaced by a sharp transition from the divider 18 to the main body 15. The divider 18 extends approximately from a point of intersection S₁ between an end face 21, facing away from the head support 13, of the main support 14 with a front edge 22, pointing in the transport direction T, of the main support 14, in the opposite direction to the transport direction T, approximately to a point of intersection S₂ between an end face 23, facing the head support 13, of the main support 14 with a rear edge 24, pointing in the opposite direction to the transport direction T, of the main support 14. As shown in the figures, the divider 18 can also begin and/or end slightly away from the points of intersection S₁, S₂, or at a distance from the front edge 22 or rear edge 24. Owing to the oblique position of the divider 18, an angle β is formed between the longitudinal axis L of the trough 10, which is oriented parallel to a longitudinal axis L_{H} of the main support 14, and the longitudinal axis L_{T} of the divider 18. This angle β enclosed between the longitudinal axis L of the trough 10 and the longitudinal axis L_{T} of the divider 18 has in particular a size between 15 and 20 degrees.

Like the main support 14, each head support 13 also comprises a main body 25 having a support surface 26 parallel to the transport plane E and a contact surface 27 oriented substantially perpendicular to the support surface 26, wherein the contact surface 27 of the head support 13 is configured at a rear edge 28, trailing in the transport direction T, of the head support 13 and extends as a continuation of the contact surface 17 of the main support 14. Both the contact surface 17 of the main support 14 and the contact surface 27 of the head support 13 have a material recess. The divider 18 has in the region of the side facing the head support 13 an opening 29 which extends perpendicular to the transport plane E in the direction towards the support surface 16 of the main support 14. The distance of the opening 29 from the end face 23 is smaller than from the end face 21 and depends on the location of components of other apparatuses and machines which would lead to a collision during transport of the troughs 10 in the transport direction T. The opening 29 extends vertically in the direction towards the support surface 16 over only part of the height/thickness of the divider 18 and ends spaced apart from the support surface 16. The contact surface 27 of the head support 13 also has an opening 30 which extends perpendicular to the transport plane E in the direction towards the support surface 26 of the head support 13.

The thickness, or height, of the divider 18 perpendicular to the support surface 16 decreases, starting from the end face 23 facing the head support 13, in the direction towards the end face 21 opposite the head support 13. The divider 18 also has a width B transverse to the longitudinal axis L of the trough 10, which width is substantially constant at least starting from the opening 29 in the direction towards the end face 21. The divider 18 is configured integrally with the main body 15. Correspondingly, the contact surface 27 of the head support 13 is also configured integrally with the main body 25 of the head support 13. In embodiments, the components are produced from a plastics material by injection moulding, namely the head support 13 and the main support 14, form together with a fastening element 31, which is likewise produced from a plastics material by injection moulding, the trough 10.

The divider 18 divides the support surface 16 into two substantially triangular partial surfaces, wherein the partial surface pointing in the transport direction T for forming the body support region 19 is configured to be larger than the partial surface facing away from the transport direction T for forming the tail support region 20. The divider 18 separates the support surface 16 of the main support 14 diagonally and is configured and adapted on the side pointing in the transport direction T as a linear stop for the back of the fish 11 to be transported. The contact surface 27 of the head support 13 likewise forms a linear stop for the head of the fish 11. All regions of the support surface 16 of the main support 14 and the support surface 26 of the head support 13 of a trough 10 lie in the same plane parallel to the transport plane E. Not only the body support region 19 and the tail support region 20 of the main support 14, but also the support surface 26 of the head support 13 lie in a plane. Finally, the fastening element 31 of the trough 10 is also in the same plane.

The head support 13 and the main support 14 are configured as separate components and are arranged spaced apart from one another to form a gap 32. The fastening element 31 is also configured separately to the main support 14 and is likewise arranged to form a gap 33 relative thereto. The longitudinal axis L_{K} of the head support 13 is oriented at an angle to the longitudinal axis L_{H} of the main support 14. In embodiments, the longitudinal axis L_{K} of the head support 13 runs approximately parallel to the longitudinal axis L_{T} of the divider 18. The front edges 22, 34, pointing in the transport direction T, of the main support 14 and head support 13 are in each case oriented parallel to the rear edges 24, 28, pointing in the opposite direction to the transport direction T, of the main support 14 and head support 13, wherein the edges 22, 24 of the main support 14 are oriented transverse to the transport direction T and parallel to the longitudinal axis L of the trough 10 or to the longitudinal axis L_{H} of the main support 14, and the edges 28, 34 of the head support 13 are inclined obliquely backwards starting from the main support 14 in the opposite direction to the transport direction T. A longitudinal axis L_{B} of the fastening element 31 extends parallel to the longitudinal axis L_{H} of the main support 14.

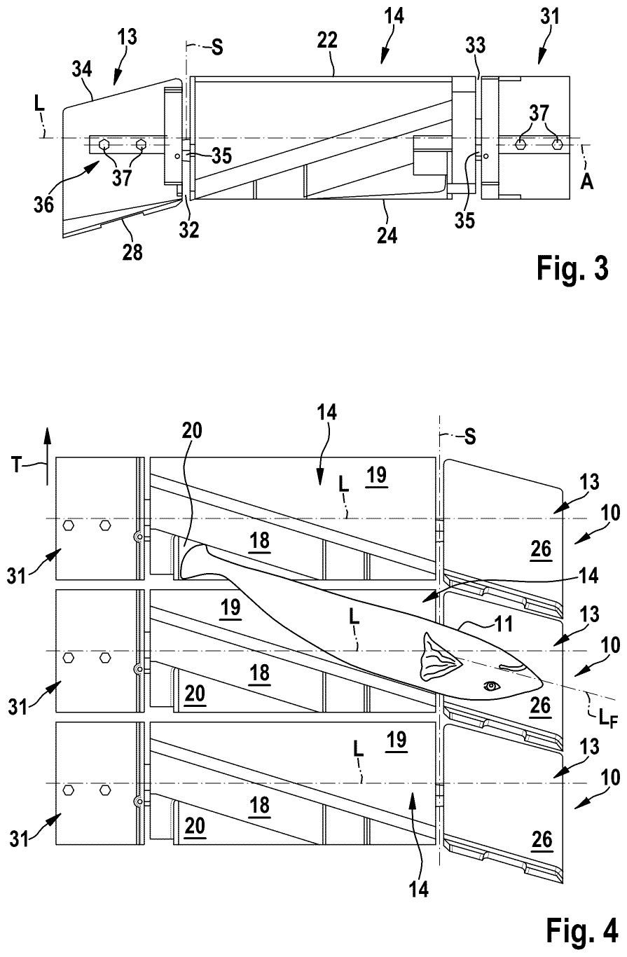

As already mentioned, each trough 10 comprises, in addition to the main support 14 and the head support 13, the fastening element 31, which is arranged at the end of the main support 14 opposite the head support 13. All three components of a trough 10, that is to say the fastening element 31, the main support 14 and the head support 13, are connected together via a bearing rod 35 or the like, wherein the main support 14 is rotatable relative to the fastening element 31 and to the head support 13. At least the fastening element 31 and the head support 13 comprise fastening means 36 by which the trough 10 is configured and adapted to be able to be mounted on a transport conveyor of a trough conveyor with its longitudinal axis L perpendicular to the transport direction T. In embodiments, threaded bores 37 are configured on the underside of the fastening element 31 and of the head support 13, which threaded bores lie on an axis A that is oriented parallel (see in particular FIG. 3) to the longitudinal axis L of the trough 10.

The troughs 10 can be used as an individual part, in particular as a replacement and/or retrofit part. However, the troughs 10 are in particular also part of a trough conveyor 38.

Therefore, the present disclosure also relates further to the trough conveyor 38, which is configured and adapted to transport fish 11 transversely to their longitudinal extent in the transport direction T. The trough conveyor 38 comprises a transport conveyor 39 which can be driven in a revolving manner and has a transport run 40 defining the transport plane E and a return run 41, wherein the endless transport conveyor 39 is guided around at least two deflection elements 42, which are rotatable about an axis of rotation D, for driving and/or guiding the transport conveyor 39. In the embodiment shown, more than two deflection elements 42 are provided, which deflection elements are not shown explicitly and may optionally also be configured and adapted as a tensioning element. Troughs 10 for receiving fish 11 are arranged on the transport conveyor 39, wherein the troughs 10 are oriented with their longitudinal axis L transverse to the transport direction T.

This trough conveyor 38 is distinguished according to the present disclosure in that each trough 10 is configured and adapted as is described in detail above.

The trough conveyor 38 comprises a plurality of troughs 10, wherein in each case two adjacent troughs 10 form a complete support for a single fish 11, such that a fish 11 can be positioned with its head on the head support 13 of a first trough 10 and with its body on the body support region 19 of the main support 14 of the first trough 10, while the tail of the same fish 11 can be positioned on the tail support region 20 of an adjacent second trough 10 that is leading in the transport direction T. All the troughs 10 are oriented with their longitudinal axis L in the transport plane E perpendicular to the transport direction T. In order to be able to transfer the processed fish 11 to a downstream processing station after a processing step, in the embodiment shown after a beheading cut, the troughs 10 are configured so as to be open on the side that is leading in the transport direction T, such that the fish 11 lying in the troughs 10 fall out of the troughs 10 in the transfer region Ü from the transport run 40 into the return run 41.

The transport conveyor 39 comprises a transport chain 43, which is formed of multiple chain members (not shown explicitly). Each trough 10 comprises, in addition to the main support 14 and the head support 13, a fastening element 31, which is arranged at the end of the main support 14 opposite the head support 13. Each trough 10 is releasably fastened in the region of the head support 13 and of the fastening element 31 to the chain members of the transport chain 43. To this end, threaded bores 37 are configured on the underside, facing the transport chain 43, of the head support 13 and of the fastening element 31, wherein all the threaded bores 37 of a trough 10 lie on an axis A which is oriented transverse to the transport direction T and parallel to the longitudinal axis L of the trough 10. To this end, the three components of a trough 10, that is to say the fastening element 31, the main support 14 and the head support 13, are connected together via a bearing rod 35, such that the main support 14 is movable, in particular rotatable, relative to the components head support 13 and fastening element 31 that are fixedly connected to the transport chain 43. The fish 11 can thus purposively be delivered from the trough conveyor 38 in the transfer region Ü.

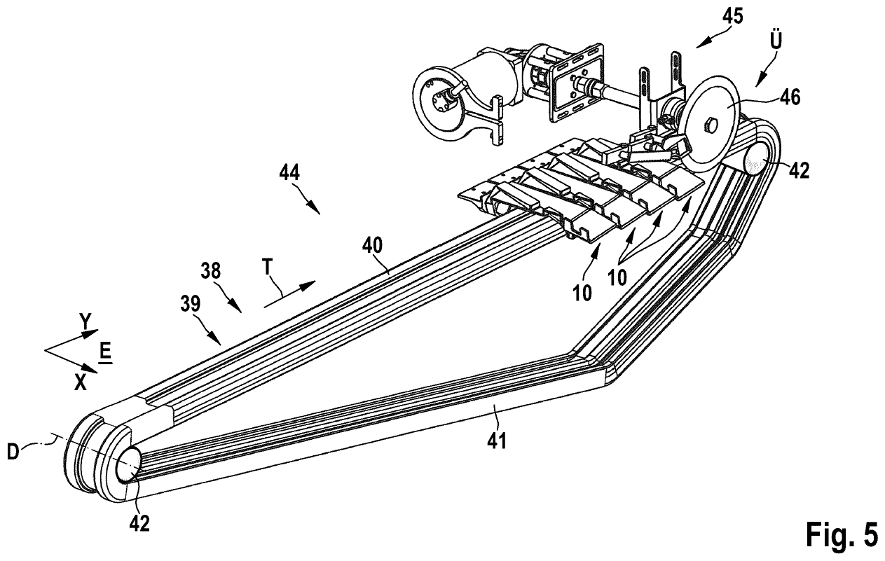

The trough conveyors 38 can be used as a stand-alone conveying element. In embodiments, however, the trough conveyors 38 are part of a processing station. In the embodiment according to FIG. 5 that is shown, the trough conveyor 38 is part of a station 44 for beheading fish 11. The station 44 for beheading comprises, in addition to the trough conveyor 38, a cutting device 45 having a separating means, in embodiments a circular knife 46, which can be driven in rotation and which, for separating the head from the body, enters the gap 32 between the head support 13 and the main support 14, and a control device (not shown explicitly). For the beheading, the trough conveyor 38 is moved, in embodiments continuously, in the transport direction T, wherein the fish 11—compelled by the configuration according to the present disclosure of the troughs 10, which themselves are oriented perpendicular to the transport direction T with their longitudinal axis L in the transport plane E—meet the circular knife 46 obliquely, that is to say with their longitudinal axis L_{F} substantially parallel to the longitudinal axis L_{T} of the divider 18, so that a yield-efficient beheading cut is made along the separating plane S.

1. A trough configured to receive fish which are able to be transported transversely to a longitudinal extent of the fish in a substantially horizontal transport plane in a transport direction by a trough conveyor, the trough comprising:
at least one head support; and
at least one main support,
wherein each main support comprises a main body having a support surface parallel to the transport plane and a contact surface oriented substantially perpendicular to the support surface,
wherein the contact surface is formed by a divider oriented at an angle β≠0 relative to a longitudinal axis of the trough, and
wherein the divider divides the support surface of the main support into two separate regions, the two separate regions including a body support region and a tail support region.

2. The trough according to claim 1, wherein the divider extends from a first point of intersection between an end face, facing away from the head support, of the main support with a front edge, pointing in the transport direction T, of the main support, in an opposite direction to the transport direction, to a second point of intersection between an end face, facing the head support, of the main support with a rear edge, pointing in the opposite direction to the transport direction, of the main support.

3. The trough according to claim 1, wherein each head support comprises a main body having a support surface parallel to the transport plane and a contact surface oriented substantially perpendicular to the support surface, wherein the contact surface of the head support is configured at a rear edge, trailing in the transport direction, of the head support and extends as a continuation of the contact surface of the main support.

4. The trough according to claim 1, wherein the divider has, in a region of a side facing the head support, an opening which extends perpendicular to the transport plane in a direction towards the support surface of the main support.

5. The trough according to claim 3, wherein the contact surface of the head support has an opening which extends perpendicular to the transport plane in a direction towards the support surface of the head support.

6. The trough according to claim 3, wherein the support surface of the main support and the support surface of the head support of the trough lie in the same plane parallel to the transport plane.

7. The trough according to claim 1, wherein the divider separates the support surface of the main support diagonally and the divider is configured on a side pointing in the transport direction as a linear stop for a back of the fish to be transported.

8. The trough according to claim 1, wherein the angle β enclosed between the longitudinal axis of the trough and a longitudinal axis of the divider has a size between 5 and 45 degrees.

9. The trough according to claim 1, wherein the divider is configured integrally with the main body.

10. The trough according to claim 1, wherein the divider divides the support surface into two substantially triangular partial surfaces, the two substantially triangular partial surfaces includes a partial surface pointing in the transport direction for forming the body support region and a partial surface facing away from the transport direction for forming the tail support region,
wherein the partial surface pointing in the transport direction for forming the body support region is configured to be larger than the partial surface facing away from the transport direction for forming the tail support region.

11. The trough according to claim 1, wherein a thickness of the divider perpendicular to the support surface decreases, starting from an end face facing the head support, in a direction towards an end face opposite the head support.

12. The trough according to claim 1, wherein the head support and the main support are configured as separate components and are arranged spaced apart from one another to form a gap.

13. The trough according to claim 1, wherein a longitudinal axis of the head support is oriented at an angle to a longitudinal axis of the main support.

14. The trough according to claim 13, wherein front edges, pointing in the transport direction, of the main support and the head support are in each case oriented parallel to rear edges, pointing in an opposite direction to the transport direction, of the main support and the head support,
wherein edges of the main support are oriented transverse to the transport direction and parallel to the longitudinal axis of the trough, and edges of the head support are inclined obliquely backwards, starting from the main support, in the opposite direction to the transport direction.

15. The trough according to claim 1, wherein the trough comprises a fastening element which is arranged at an end of the main support opposite the head support.

16. The trough according to claim 15, wherein the fastening element, the main support and the head support, are connected together via a bearing rod.

17. The trough according to claim 15, wherein at least the fastening element and the head support comprise fastening means by which the trough is configured to be mounted on a transport conveyor with a longitudinal axis perpendicular to the transport direction.

18. A trough conveyor configured to transport fish transversely to a longitudinal extent of the fish in a transport direction, the trough conveyor comprising:
a transport conveyor configured to be driven in a revolving manner, having a transport run defining a transport plane and a return run, the transport conveyor is guided around at least two deflection elements, which are rotatable about an axis of rotation, for driving and/or guiding the transport conveyor; and
troughs for receiving the fish are arranged on the transport conveyor,
wherein the troughs are oriented with their longitudinal axis transverse to the transport direction T, and
each trough is configured according to claim 1.

19. The trough conveyor according to claim 18, wherein two adjacent troughs form a complete support for a single fish, such that the single fish can be positioned with its head on the head support of a first trough and with its body on the body support region of the main support of the first trough, while a tail of the single fish can be positioned on the tail support region of an adjacent second trough that is leading in the transport direction.

20. The trough conveyor according to claim 18, wherein the longitudinal axis of each trough is oriented in the transport plane perpendicular to the transport direction.

21. The trough conveyor according to claim 18, wherein the troughs are configured so as to be open on a side that is leading in the transport direction, such that the fish lying in the troughs fall out of the troughs in a transfer region from the transport run into the return run.

22. The trough conveyor according to claim 18, wherein the transport conveyor comprises a transport chain formed of multiple chain members.

23. The trough conveyor according to claim 22, wherein each trough comprises a fastening element which is arranged at an end of the main support opposite the head support, wherein each trough is releasably fastened in a region of the head support and of the fastening element to the chain members of the transport chain.

24. The trough conveyor according to claim 23, wherein threaded bores are configured on an underside, facing the transport chain, of the head support and of the fastening element, wherein the threaded bores of the trough lie on an axis which is oriented transverse to the transport direction and parallel to the longitudinal axis of the trough.

25. The trough conveyor according to claim 23, wherein the fastening element, the main support and the head support, are connected together via a bearing rod, such that the main support is movable relative to the head support and the fastening element that are fixedly connected to the transport chain.
